(19) United States
(12) Patent Application Publication
(10) Pub. No.: US 2011/0231430 A1
(43) Pub. Date: Sep. 22, 2011

(54) CONTENT COLLECTING APPARATUS, CONTENT COLLECTING METHOD, AND NON-TRANSITORY COMPUTER-READABLE RECORDING MEDIUM ENCODED WITH CONTENT COLLECTING PROGRAM

(75) Inventors: Kazumi SAWAYANAGI, Itami-shi (JP); Hideyuki MATSUDA, Hirakata-shi (JP); Toshihiko OTAKE, Ikeda-shi (JP); Kazusei TAKAHASHI, Nishinomiya-shi (JP); Masayuki KAWAMOTO, Amagasaki-shi (JP)

(73) Assignee: Konica Minolta Business Technologies, Inc., Tokyo (JP)

(21) Appl. No.: 13/043,212

(22) Filed: Mar. 8, 2011

(30) Foreign Application Priority Data
Mar. 18, 2010 (JP) 2010-062061

(51) Int. Cl. G06F 17/30

(52) U.S. Cl. 707/769; 707/E17.014

(57) ABSTRACT

A content collecting apparatus includes a portion accepting a key sentence, a portion extracting keywords from the key sentence, a portion setting the keywords as search keywords, a portion acquiring contents extracted by performing search using the search keywords, a portion selecting at least one of the acquired contents, a portion storing the selected content, a portion storing history data in which the selected content is associated with the key sentence, a portion acquiring a new key sentence, a portion extracting new keywords from the new key sentence, a portion adding the new keywords to the search keywords, a portion acquiring contents extracted by performing search using the search keywords, a portion selecting at least one of the acquired contents, a portion additionally storing the newly selected content, and a portion adding to the history data new history data in which the newly selected content is associated with the new key sentence.

This application is based on Japanese Patent Application No. 2010-062061 filed with Japan Patent Office on Mar. 18, 2010, the entire content of which is hereby incorporated by reference.

### BACKGROUND OF THE INVENTION

1. Field of the Invention

The present invention relates to a content collecting apparatus, a content collecting method, and a non-transitory computer-readable recording medium encoded with a computer collecting program. More particularly, the present invention relates to a content collecting apparatus which collects contents retrieved by a search engine, a content collecting method which is performed by the content collecting apparatus, and a non-transitory computer-readable recording medium encoded with a content collecting program which is executed by the content collecting apparatus.

2. Description of the Related Art

As a technique of extracting a desired content from among a large number of contents, a technique of inputting a keyword for searching a database or the like is known. For example, Japanese Patent Laid-Open No. 10-40403 discloses a graphics editing apparatus, wherein in the case where a graphic transformation instruction is input from an editing instruction input portion with respect to a graphic that is being edited, a graphic transformation knowledge management portion searches a graphic transformation knowledge storage portion using the selected graphic data as a request condition by a user, and a transformation candidate graphic displaying portion displays the search result as candidate graphics. A graphic transformation portion retrieves transformed graphic data that has been selected and determined by the user from the candidate graphics, and combines that transformed graphic data with non-transformed graphic data.

In particular, with the recent proliferation of the Internet, a user is capable of accessing a huge number of contents available throughout the world. A search server is provided on the Internet, which may be used to extract an appropriate content out of the huge number of contents.

In the case of creating a document for presentation, however, if it is necessary to search for a content to be referenced during the creation of the document, the document-creating job is interrupted, leading to degradation of work efficiency. Furthermore, in the case where the document-creating job is interrupted by a meeting or the like, it will take some time for the user to recall how the document had been created to that point, by only referring to the document created up to then.

### SUMMARY OF THE INVENTION

The present invention has been accomplished in view of the foregoing problems, and an object of the present invention is to provide a content collecting apparatus which is capable of storing the process in which a plurality of contents were determined.

Another object of the present invention is to provide a content collecting method which enables storage of the process in which a plurality of contents were determined.

Yet another object of the present invention is to provide a non-transitory computer-readable recording medium encoded with a content collecting program which enables storage of the process in which a plurality of contents were determined.

In order to achieve the above-described objects, according to an aspect of the present invention, there is provided a content collecting apparatus which includes: a key sentence accepting portion to accept a key sentence externally input; a first keyword extracting portion to extract one or more keywords from the accepted key sentence; a keyword setting portion to set the extracted one or more keywords as search keywords; a first content acquiring portion, in response to an event that the extracted one or more keywords are set as search keywords by the keyword setting portion, to acquire one or more contents extracted by performing search using the one or more keywords set as the search keywords; a first selecting portion to select at least one of the one or more contents acquired by the first content acquiring portion; a content storing portion to store the content selected by the first selecting portion; a history storing portion to store history data in which the content selected by the first selecting portion is associated with the key sentence accepted by the key sentence accepting portion; a key sentence acquiring portion to acquire a new key sentence; a second keyword extracting portion, in response to an event that a new key sentence is acquired by the key sentence acquiring portion, to extract one or more new keywords from the acquired new key sentence; a keyword adding portion, in response to an event that one or more new keywords are extracted, to add the extracted one or more new keywords to the search keywords; a second content acquiring portion, in response to an event that the one or more new keywords are added to the search keywords, to acquire one or more contents extracted by performing search using the one or more keywords set as the search keywords; a second selecting portion to select at least one of the one or more contents acquired by the second content acquiring portion; a content adding and storing portion to add the content selected by the second selecting portion to the stored content for storage; and a history adding portion, in response to an event that the content is selected by the second selecting portion, to add to the stored history data new history data in which the selected content is associated with the acquired new key sentence.

According to another aspect of the present invention, there is provided a content collecting method, which includes: a step of accepting a key sentence externally input; a step of extracting one or more keywords from the accepted key sentence; a step of setting the extracted one or more keywords as search keywords; a first acquiring step of, in response to an event that the extracted one or more keywords are set as search keywords, acquiring one or more contents extracted by performing search using the one or more keywords set as the search keywords; a first selecting step of selecting at least one of the one or more contents acquired in the first acquiring step; a step of storing the content selected in the first selecting step; a step of storing history data in which the content selected in the first selecting step is associated with the externally input key sentence; a step of acquiring a new key sentence; a step of, in response to an event that the new key sentence is acquired, extracting one or more new keywords from the acquired new key sentence; a step of, in response to an event that one or more new keywords are extracted, adding the extracted one or more new keywords to the search keywords; a second acquiring step of, in response to an event that the one or more new keywords are added to the search keywords, acquiring one or more contents extracted by performing search using the one or more keywords set as the search keywords; a second selecting step of selecting at least one of the one or more contents acquired in the second acquiring step; a step of adding the content selected in the second selecting step to the stored content for storage; and a step of, in response to an event that the content is selected in the second selecting step, adding to the stored history data new history data in which the selected content is associated with the acquired new key sentence.

According to yet another aspect of the present invention, there is provided a non-transitory computer-readable recording medium encoded with a content collecting program, wherein the content collecting program causes a computer to execute: a step of accepting a key sentence externally input; a step of extracting one or more keywords from the accepted key sentence; a step of setting the extracted one or more keywords as search keywords; a first acquiring step of, in response to an event that the extracted one or more keywords are set as search keywords, acquiring one or more contents extracted by performing search using the one or more keywords set as the search keywords; a first selecting step of selecting at least one of the one or more contents acquired in the first acquiring step; a step of storing the content selected in the first selecting step; a step of storing history data in which the content selected in the first selecting step is associated with the externally input key sentence; a step of acquiring a new key sentence; a step of, in response to an event that the new key sentence is acquired, extracting one or more new keywords from the acquired new key sentence; a step of, in response to an event that one or more new keywords are extracted, adding the extracted one or more new keywords to the search keywords; a second acquiring step of, in response to an event that the one or more new keywords are added to the search keywords, acquiring one or more contents extracted by performing search using the one or more keywords set as the search keywords; a second selecting step of selecting at least one of the one or more contents acquired in the second acquiring step; a step of adding the content selected in the second selecting step to the stored content for storage; and a step of, in response to an event that the content is selected in the second selecting step, adding to the stored history data new history data in which the selected content is associated with the acquired new key sentence.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows, by way of example, an information processing system according to an embodiment of the present invention;

FIG. 2 is a block diagram showing an example of the hardware configuration of a PC;

FIG. 3 is a block diagram schematically showing the functions of a CPU included in an MFP, together with information stored in a HDD;

FIG. 4 shows an example of a selection image;

FIG. 5 shows, by way of example, how the content and the key sentence are displayed;

FIGS. 6 and 7 show a flowchart illustrating an example of the flow of a content collecting process; and

FIG. 8 is a flowchart illustrating an example of the flow of a history displaying process.

### DESCRIPTION OF THE PREFERRED EMBODIMENTS

Embodiment of the present invention will now be described with reference to the drawings. In the following description, like reference characters denote like parts, which have like names and functions, and therefore, detailed description thereof will not be repeated.

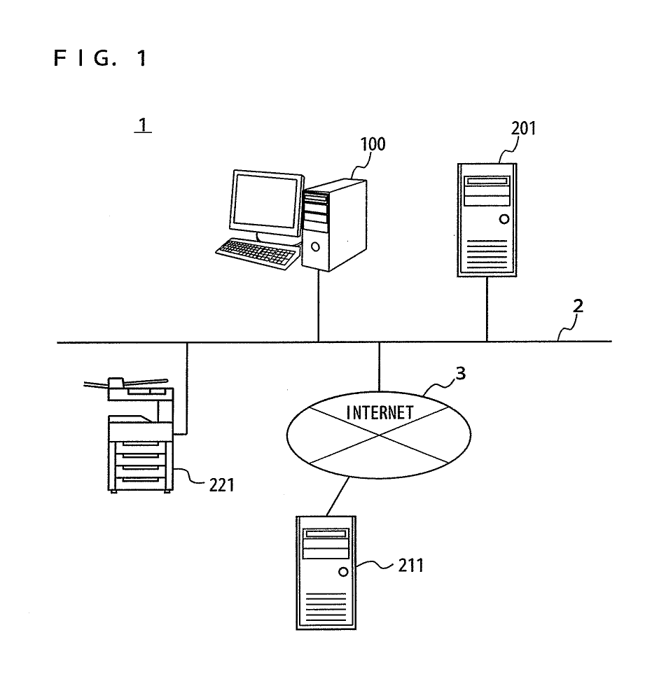

FIG. 1 shows an example of an information processing system according to an embodiment of the present invention. Referring to FIG. 1, an information processing system 1 includes a personal computer (PC) 100 serving as a content collecting apparatus, a file server 201, and a multi-function peripheral (hereinafter, referred to as “MFP”) 221. PC 100, file server 201, and MFP 221 are each connected to a network 2. MFP 221 includes a HDD, and has a function as a file server. MFP 221 also has a scanner function, a printer function, a copy function, a facsimile function, and other functions.

MFP 221 and file server 201 each store a plurality of contents. For example in the case where two or more persons share file server 201, file server 201 stores a plurality of contents that the persons have stored therein. File server 201 includes a search engine. When a keyword is transmitted from PC 100 to file server 201, file server 201 extracts, from among the plurality of contents stored in file server 201, any content that includes that keyword, and transmits the extracted contents to PC 100. The contents transmitted from file server 201 have been sorted in a predetermined priority order in file server 201.

Network 2 is a local area network (LAN), which may be connected in a wired or wireless manner. Network 2 is connected via a gateway to the Internet 3, allowing PC 100 to communicate with a search server 211 connected to the Internet 3. Network 2 is not limited to the LAN, but may be a wide area network (WAN), public switched telephone networks (PSTN), or the like.

Search server 211 includes a search engine, and provides a service of searching contents published on the Internet 3 and outputting the search result. Search server 211 sorts the retrieved contents in a predetermined priority order in search server 211, before outputting the same. When PC 100 transmits a keyword to search server 211, PC 100 receives a plurality of contents extracted as the search result from search server 211.

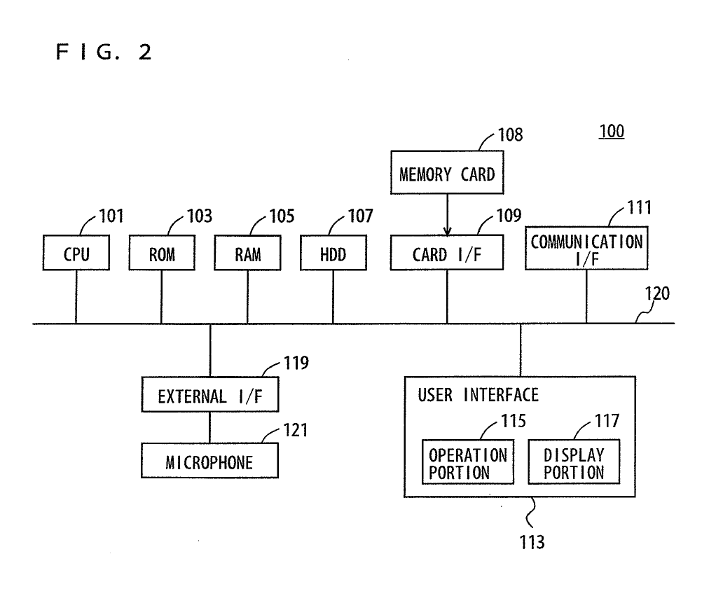

FIG. 2 is a block diagram showing an example of the hardware configuration of the PC. Referring to FIG. 2, PC 100 includes: a CPU 101, a read only memory (ROM) 103 for storing a program to be executed by CPU 101 and others; a random access memory (RAM) 105 used as a work area for CPU 101; a HDD 107 as a mass storage; a card interface (I/F) 109 to which a memory card 108 is mounted; a communication I/F 111 for connecting PC 100 to the Internet; a user interface 113 which serves as an interface with a user; and an external I/F 119 to which a microphone 121 is connected. The above components in PC 100 are each connected to a bus 120.

User interface 113 includes an operation portion 115 which includes a pointing device such as a mouse and a keyboard, and a display portion 117 for displaying data, which may be a liquid crystal display or the like.

CPU 101 is responsible for overall control of PC 100. CPU 101 executes a program stored in ROM 103. Alternatively, CPU 101 may be configured to load a program stored in memory card 108 via card I/F 109 to RAM 105 for execution.

Still alternatively, CPU 101 may download a program from a computer connected to the Internet 3 and store the same in HDD 107, or a computer connected to the Internet 3 may write a program into HDD 107, and CPU 101 may execute the program. As used herein, the “program” includes, not only the program which CPU 101 can execute directly, but also a source program, a compressed program, an encrypted program, and others.

Microphone 121 collects speech uttered by a user of PC 100, and outputs the collected speech to external I/F 119. External I/F 119 outputs the speech input from microphone 121 to CPU 101.

It is noted that the recording medium for storing the program to be executed by CPU 101 is not restricted to memory card 108. It may be a flexible disk, a cassette tape, an optical disc (compact disc-ROM (CD-ROM), magneto-optical (MO) disc, mini disc (MD), digital versatile disc (DVD)), an IC card, an optical card, or a semiconductor memory such as a mask ROM, an erasable and programmable ROM (EPROM), an electrically erasable and programmable ROM (EEPROM), or the like.

PC 100 according to the present embodiment functions as a content collecting apparatus. PC 100 collects, from among the contents published on the Internet or stored in file server 201 or MFP 221, any content desired by a user of PC 100. It is here assumed that the user of PC 100 collects contents to be referenced for creating a document for presentation. In this case, with the presentation having a theme, the contents to be collected are those related to that theme. Here, it is assumed that the presentation theme is “Cloud computing will spread in the future”.

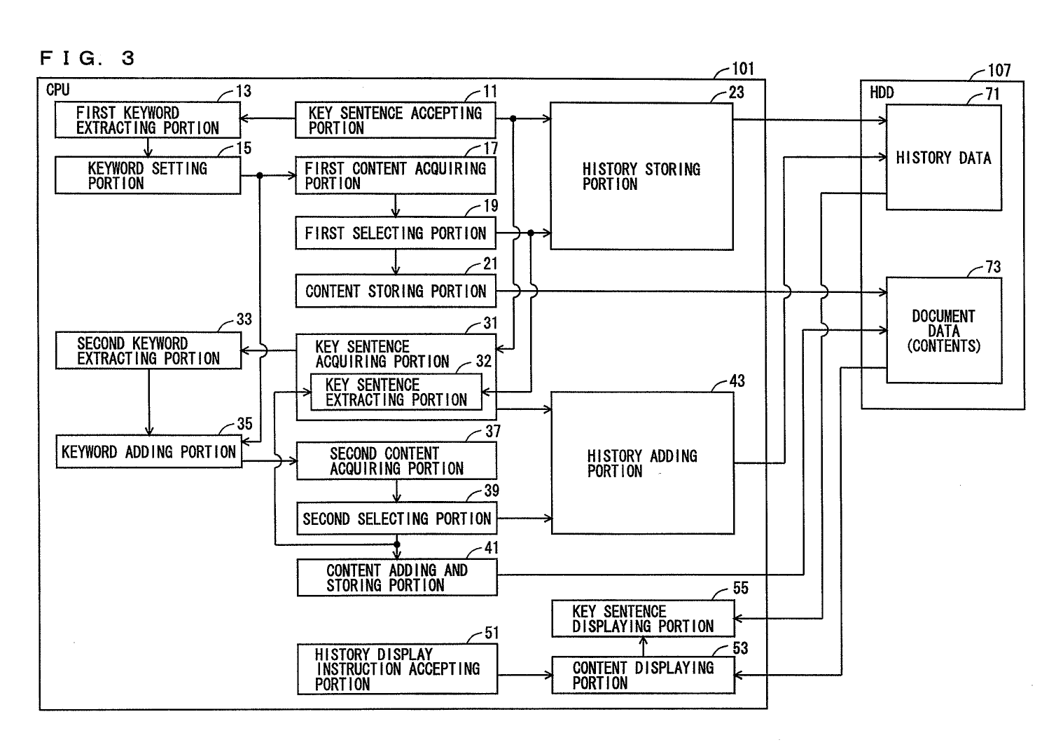

FIG. 3 is a block diagram schematically showing the functions of the CPU included in the PC, together with information stored in the HDD. The functions shown in FIG. 3 are formed in CPU 101 as CPU 101 executes a content collecting program stored in ROM 103 or memory card 108.

Referring to FIG. 3, CPU 101 includes: a key sentence accepting portion 11 which accepts a key sentence externally input; a first keyword extracting portion 13 which extracts keywords from the key sentence; a keyword setting portion 15 which sets the keywords as search keywords; a first content acquiring portion 17 which acquires contents; a first selecting portion 19 which selects at least one content from the acquired contents; a content storing portion 21 which stores a content; a history storing portion 23 which stores history data in which a content is associated with a key sentence; a key sentence acquiring portion 31 which acquires a new key sentence; a second keyword extracting portion 33 which extracts one or more new keywords from the new key sentence; a keyword adding portion 35 which adds the one or more new keywords to the search keywords; a second content acquiring portion 37 which uses the one or more keywords set as the search keywords to perform search to thereby acquire one or more contents extracted; a second selecting portion 39 which selects at least one content from the acquired contents; a content adding and storing portion 41 which stores the selected content additionally; a history adding portion 43 which adds new history data in which a content is associated with a new key sentence; a history display instruction accepting portion 51; a content displaying portion 53 which displays a content; and a key sentence displaying portion 55 which displays a key sentence.

Key sentence accepting portion 11 accepts a key sentence input by a user. The key sentence refers to a sentence including at least one word. It is here assumed that the presentation theme “Cloud computing will spread in the future” is accepted as the key sentence. In the case where a user inputs the key sentence to operation portion 115, key sentence accepting portion 11 accepts the key sentence input to operation portion 115. In the case where a user inputs the key sentence as speech into microphone 121, key sentence accepting portion 11 accepts the speech input to microphone 121 via external I/F 119, and performs speech recognition of the accepted speech to thereby accept the key sentence. Key sentence accepting portion 11 outputs the accepted key sentence to first keyword extracting portion 13, history storing portion 23, and key sentence acquiring portion 31.

First keyword extracting portion 13 divides the key sentence input from key sentence accepting portion 11 into one or more words, and extracts, from the one or more words, any word that coincides with the word registered in advance, as a keyword. First keyword extracting portion 13 outputs the extracted one or more keywords to keyword setting portion 15. Here, from the key sentence “Cloud computing will spread in the future”, the words “cloud” and “spread”, registered in advance, are extracted as the keywords.

Keyword setting portion 15 sets the one or more keywords input from first keyword extracting portion 13 as search keywords. Specifically, keyword setting portion 15 stores the one or more keywords input from first keyword extracting portion 13 in an area that is prepared in RAM 105 for storing the search keywords therein. Keyword setting portion 15 outputs the search keywords to first content acquiring portion 17 and keyword adding portion 35.

First content acquiring portion 17 performs search using the search keywords, to acquire one or more contents, and outputs the acquired contents to first selecting portion 19. Specifically, first content acquiring portion 17 transmits a search request including the search keywords to search server 211 via communication I/F 111. On receipt of the search request, search server 211 extracts one or more contents including the search keywords from among a huge number of contents published on the Internet 3, sorts the one or more contents in a predetermined priority order, and returns the contents to PC 100. In the case where communication I/F 111 receives from search server 211 one or more contents as the search result, first content acquiring portion 17 acquires the one or more contents from communication I/F 111. First content acquiring portion 17 then sorts the one or more contents received from search server 211 in such a manner that a content including an image is given a higher priority than a content including no image, because the content including an image has a greater utility value as a document for use in presentation than the content including no image.

First content acquiring portion 17 may be configured to transmit a search request including the search keywords to file server 201 or MFP 221. On receipt of the search request, file server 201 extracts one or more contents including the search keywords from among a plurality of contents stored in the HDD included in file server 201, sorts the extracted contents in a priority order predetermined by file server 201, and returns the contents to PC 100. In the case where communication I/F 111 receives the one or more contents from file server 201 as the search result, first content acquiring portion 17 acquires the one or more contents from communication I/F 111. When MFP 221 receives a search request, it extracts one or more contents including the search keywords from among a plurality of contents stored in the HDD included in MFP 221, sorts the extracted contents in a priority order predetermined by MFP 221, and returns the contents to PC 100. In the case where communication I/F 111 receives the one or more contents from MFP 221 as the search result, first content acquiring portion 17 acquires the one or more contents from communication I/F 111.

First selecting portion 19 extracts top three contents in terms of priority from among the one or more contents input from first content acquiring portion 17, and displays the three contents on display portion 117 in a selectable manner. Specifically, first selecting portion 19 generates a selection image by combining images of the top three contents so as to allow any of the images corresponding respectively to the contents to be selected by the user, and displays the generated selection image on display portion 117. In the case where the selection image has a size greater than the size displayable on display portion 117, the selection image may be reduced in size, or may be displayed so that it can be scrolled.

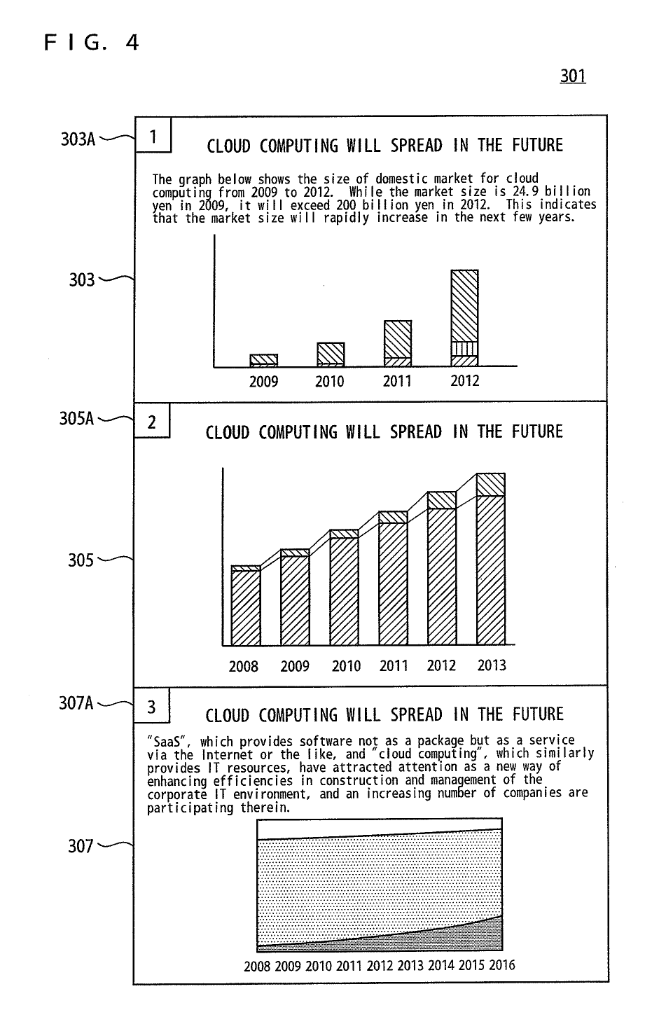

FIG. 4 shows an example of a selection image. Referring to FIG. 4, a selection image 301 includes an image 303 of the content that is the highest in priority order, an image 305 of the content that is the second highest in priority order, and an image 307 of the content that is the third highest in priority order. An image 303A, which is arranged on the upper left corner of content image 303, indicates that the content corresponding to image 303 has the highest priority and allows selection of image 303. An image 305A, which is arranged on the upper left corner of content image 305, indicates that the content corresponding to image 305 has the second highest priority and allows selection of image 305. An image 307A, which is arranged on the upper left corner of content image 307, indicates that the content corresponding to image 307 has the third highest priority and allows selection of image 307.

Returning to FIG. 3, in the case where a user inputs to operation portion 115 an operation of designating image 303A included in selection image 301 displayed on display portion 117, first selecting portion 19 selects the content having the highest priority. When a user inputs to operation portion 115 an operation of designating image 305A, first selecting portion 19 selects the content having the second highest priority. When a user inputs to operation portion 115 an operation of designating image 307A, first selecting portion 19 selects the content having the third highest priority. First selecting portion 19 outputs the selected content to content storing portion 21 and history storing portion 23.

Content storing portion 21 stores the content input from first selecting portion 19 as document data 73 in HDD 107.

History storing portion 23 receives a content from first selecting portion 19 and a key sentence from key sentence accepting portion 11. History storing portion 23 generates a history record in which the key sentence and the content are associated with each other, and stores the generated history record as history data 71 in HDD 107. History data 71 includes one or more history records. Each history record includes content identification information for identifying the content input from first selecting portion 19, and the key sentence input from key sentence accepting portion 11. It is noted that the history record may include the content itself that is input from first selecting portion 19.

Key sentence acquiring portion 31 acquires a new key sentence, either by accepting a new key sentence input by the user, or by extracting a new key sentence from the selected content. Key sentence acquiring portion 31 outputs the acquired key sentence to second keyword extracting portion 33 and history adding portion 43.

Key sentence acquiring portion 31 determines whether to accept a new key sentence input by the user or extract a new key sentence from the selected content, in accordance with the user's selection. In the case of accepting a new key sentence input by the user, key sentence acquiring portion 31 accepts the key sentence that has been newly accepted by key sentence accepting portion 11. In the case of extracting a new key sentence from the selected content, key sentence acquiring portion 31 acquires the key sentence extracted by a key sentence extracting portion 32 which is included in key sentence acquiring portion 31.

When a content is input from first selecting portion 19, key sentence extracting portion 32 extracts a key sentence from the text included in the content. When a content is input from second selecting portion 39, which will be described later, key sentence extracting portion 32 extracts a key sentence from the text included in the content. For extracting a key sentence, key sentence extracting portion 32 extracts a sentence that includes at least one of the search keywords stored in RAM 105, as the key sentence. It is noted that a user may designate a new key sentence from within the content. Here, it is assumed that a user has input a new key sentence “Press release”.

Second keyword extracting portion 33 divides the key sentence input from key sentence acquiring portion 31 into one or more words, and extracts, from the one or more words, any word that coincides with the word registered in advance, as a keyword. Second keyword extracting portion 33 outputs the extracted one or more keywords to keyword adding portion 35. Here, from the new key sentence “Press release”, the words “press” and “release”, registered in advance, are extracted as the keywords.

Keyword adding portion 35 adds the one or more keywords input from second keyword extracting portion 33 to the search keywords. Specifically, keyword adding portion 35 additionally stores the one or more keywords input from second keyword extracting portion 33 in the area prepared in RAM 105 for storing the search keywords therein. Keyword adding portion 35 outputs the search keywords to second content acquiring portion 37.

Second content acquiring portion 37, likewise first content acquiring portion 17, performs search using the search keywords to acquire one or more contents, and outputs the acquired one or more contents to second selecting portion 39. The search keywords in this case are “cloud”, “spread”, “press”, and “release”. Further, second content acquiring portion 37 sorts the one or more contents received from search server 211 in such a manner that a content including an image is given a higher priority than a content including no image, because the content including an image has a greater utility value as a document for use in presentation than the content including no image.

Second selecting portion 39, likewise first selecting portion 19, extracts top three contents in terms of priority from among the one or more contents input from second content acquiring portion 37, and displays the three contents on display portion 117 in a selectable manner. Specifically, second selecting portion 39 generates a selection image by combining images of the top three contents so as to allow any of the images corresponding respectively to the contents to be selected by the user, and displays the generated selection image on display portion 117. Second selecting portion 39 accepts a selection operation performed by a user on the basis of the selection image displayed on display portion 117, and outputs the selected content to content adding and storing portion 41, history adding portion 43, and key sentence extracting portion 32.

Content adding and storing portion 41 stores the content input from second selecting portion 39 additionally in document data 73 that is stored in HDD 107.

History adding portion 43 receives a content from second selecting portion 39, and receives a new key sentence from key sentence acquiring portion 31. History adding portion 43 generates a history record in which the key sentence and the content are associated with each other, and stores the generated history record additionally in history data 71 that is stored in HDD 107.

When a new content is selected by second selecting portion 39, the selected content is output to key sentence extracting portion 32. Key sentence extracting portion 32 in turn extracts a new key sentence from the new content. Accordingly, the processes of selecting a content, extracting a key sentence, extracting keywords, and searching for contents are repeated until the user inputs an end instruction.

History display instruction accepting portion 51 accepts a history display instruction when the user presses a key prepared in operation portion 115. On receipt of the history display instruction, history display instruction accepting portion 51 outputs a display instruction to content displaying portion 53.

Content displaying portion 53 displays on display portion 117 the content included in document data 73 stored in HDD 107. In the case where document data 73 includes a plurality of contents, content displaying portion 53 displays the contents one after another on display portion 117. Content displaying portion 53 outputs, to key sentence displaying portion 55, the content identification information for the content being displayed on display portion 117. Content displaying portion 53 switches the content being displayed on display portion 117 to the next content in accordance with the user instruction. Every time content displaying portion 53 switches the content being displayed, it outputs to key sentence displaying portion 55 the content identification information for the content that is newly displayed.

On receipt of the content identification information, key sentence displaying portion 55 extracts, from among the history records included in history data 71 stored in HDD 107, the history record that includes the content identification information input from content displaying portion 53. Key sentence displaying portion 55 then acquires the key sentence that is associated with the content identification information by the extracted history record. Key sentence displaying portion 55 displays the acquired key sentence so as to be superimposed on the content being displayed on display portion 117. As a result, the key sentence including the keywords used for searching for the content being displayed is displayed, which can notify the user of the relationship between the key sentence and the content. Further, when another content is displayed by content displaying portion 53, the key sentence including the keywords used for searching for that other content is displayed. As such, when two or more contents are displayed in turn, the key sentences which are associated with the contents being displayed are displayed correspondingly. This allows the user to recall the thought process on the basis of the relationships between the key sentences and the contents.

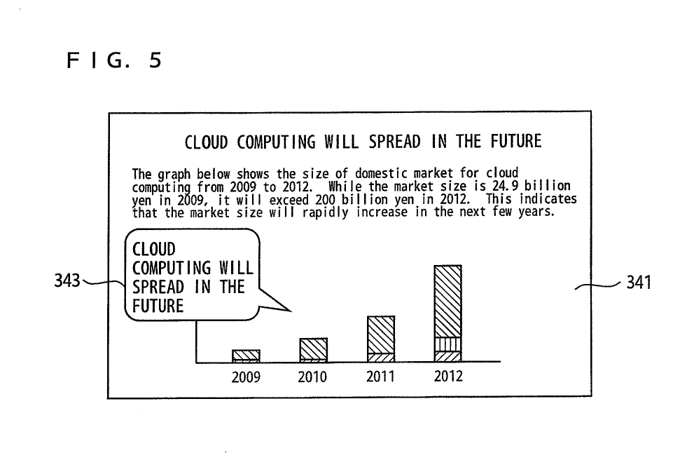

FIG. 5 shows, by way of example, how the content and the key sentence are displayed. Referring to FIG. 5, a key sentence 343 is displayed in relation to a content 341.

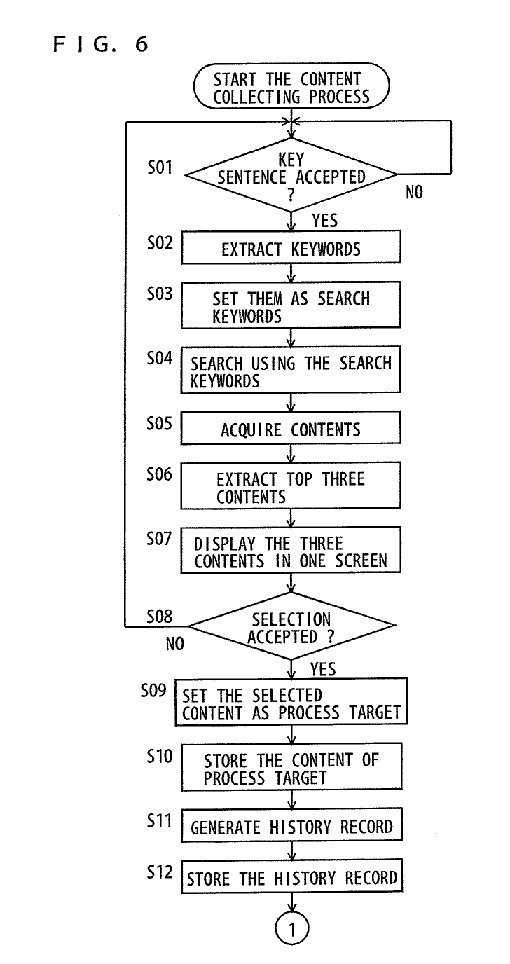

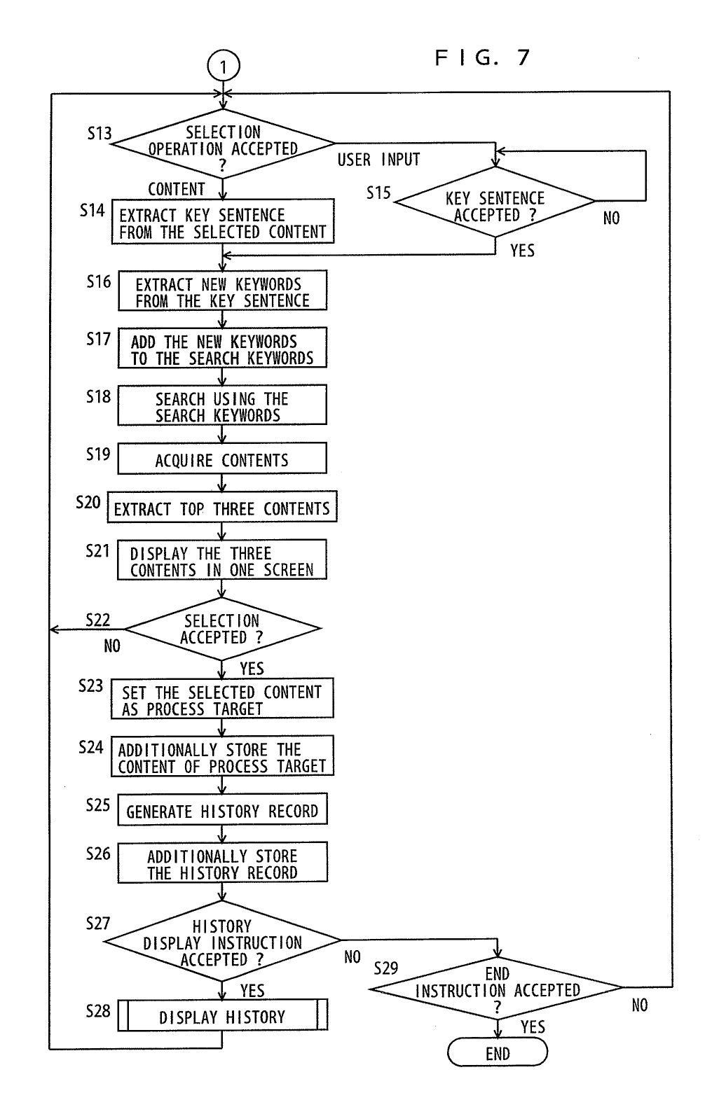

FIGS. 6 and 7 show a flowchart illustrating an example of the flow of a content collecting process. The content collecting process is performed by CPU 101 as CPU 101 executes a content collecting program stored in ROM 103 or memory card 108. Referring to FIGS. 6 and 7, CPU 101 is in a standby mode until a key sentence is accepted (NO in step S01), and once the key sentence is accepted, the process proceeds to step S02. When a user inputs a key sentence to operation portion 115, the key sentence input to operation portion 115 is accepted. When the user inputs a key sentence by speech via microphone 121, the speech input to microphone 121 is accepted via external I/F 119, and the accepted speech is subjected to speech recognition so that the key sentence is accepted.

In step S02, one or more keywords are extracted from the key sentence. From the key sentence including one or more words, any word that coincides with the word registered in advance is extracted as the keyword.

In step S03, the keywords extracted in step S02 are set as search keywords. In the following step S04, search is performed using the search keywords. Specifically, a search request including the search keywords is transmitted to search server 211 via communication I/F 111. On receipt of the search request, search server 211 extracts one or more contents including the search keywords from among a huge number of contents published on the Internet 3, sorts the contents in a predetermined priority order, and returns the contents to PC 100. It is noted that the search request including the search keywords may be transmitted to file server 201 or MFP 221.

In the following step S05, the contents transmitted from search server 211 are acquired. When communication I/F 111 receives one or more contents as the search result from search server 211, the one or more contents are acquired from communication I/F 111. In the case where the search request is transmitted to file server 201 or MFP 221, the contents transmitted from file server 201 or MFP 221 are acquired.

In the following step S06, top three contents in terms of priority are extracted from among the contents acquired from search server 211. The three contents are displayed in one screen (step S07). Specifically, the selection image shown in FIG. 4, including the images of the three contents and allowing the user to select any of the three images, is displayed on display portion 117. In the following step S08, it is determined whether an operation of selecting one of the three contents has been accepted. If the operation of selecting one of the three contents has been accepted, the process proceeds to step S09; otherwise, the process returns to step S01.

The process proceeds to step S09 in the case where one of the three contents extracted on the basis of the key sentence accepted in step S01 has been selected by the user. In step S09, the content selected in step S08 is set as a process target. Then, the content set as the process target is stored as document data 73 in HDD 107 (step S10). In the following step S11, a history record is generated. The history record includes the key sentence accepted in step S01, and the content identification information for identifying the content stored in HDD 107 in step S10. In the following step S12, the generated history record is stored as history data 71 in HDD 107, and the process proceeds to step S13.

In step S13, it is determined whether an operation of selecting a source from which a key sentence is to be accepted has been accepted. In the case where the operation of selecting a content as the source from which the key sentence is to be accepted has been accepted, the process proceeds to step S14, while in the case where the operation of selecting a user as the source from which the key sentence is to be accepted has been accepted, the process proceeds to step S15.

In step S14, a key sentence is extracted from the content being set as the process target. In the case where the process of step S14 is executed following the execution of the process in step S12, the key sentence is extracted from the content that has been selected in step S08.

In step S15, as in step S01, CPU 101 is in a standby mode until a key sentence input by the user is accepted (NO in step S15), and once a key sentence is input by the user, CPU 101 accepts the input key sentence (YES in step S15), and the process proceeds to step S16.

In step S16, a new keyword is extracted from the key sentence extracted in step S14 or from the key sentence accepted in step S15. In the case where the key sentence includes two or more words that coincide with the words predetermined as keywords, a plurality of keywords are extracted. At this time, any word that has already been set as the search keyword is not extracted.

In step S17, the one or more new keywords are added to the search keywords. Specifically, the new keywords extracted in step S16 are additionally stored in the area prepared in RAM 105 for storing the search keywords therein.

In the following step S18, search is performed using the search keywords, similarly as in step S04, but using the search keywords different from those used in step S04. Specifically, a search request including the search keywords is transmitted to search server 211 via communication I/F 111. On receipt of the search request, search server 211 extracts one or more contents including the search keywords from among a huge number of contents published on the Internet 3, sorts the one or more contents in a predetermined priority order, and returns them to PC 100.

In step S19, when communication I/F 111 receives one or more contents as the search result from search server 211, the one or more contents are acquired from communication I/F 111.

In the following step S20, top three contents in terms of priority are extracted from the contents acquired from search server 211 in step S19. The three contents are displayed in one screen (step S21). Specifically, a selection image including the images of the three contents extracted in step S20 and allowing the user to select any of the three images is displayed on display portion 117. In the following step S22, it is determined whether an operation of selecting one of the three contents has been accepted. If the operation of selecting one of the three contents has been accepted, the process proceeds to step S23; otherwise, the process returns to step S13.

The process proceeds to step S23 in the case where the user has selected one of the three contents that were extracted on the basis of the key sentence extracted from the content in step S14 or the key sentence input by the user in step S15. In step S23, the content selected in step S22 is set as a process target. Then, the content set as the process target is additionally stored as document data 73 in HDD 107 (step S24). In the following step S25, a history record is generated. The history record includes the key sentence extracted from the content in the case where step S14 is executed, or the key sentence input from the user in the case where step S15 is executed, and also includes the content identification information for identifying the content that has been added to document data 73 in HDD 107 for storage in step S24. In the following step S26, the generated history record is added to history data 71 stored in HDD 107 for storage, and the process proceeds to step S27.

In step S27, it is determined whether a history display instruction has been accepted. When the user presses a key in operation portion 115 to which a history display instruction has been assigned in advance, the history display instruction is accepted. If the history display instruction is accepted, the process proceeds to step S28; otherwise, the process proceeds to step S29. In step S29, if the user presses a key in operation portion 115 to which an end instruction has been assigned in advance, an end instruction is accepted. If the end instruction is accepted, the process is terminated; otherwise, the process returns to step S13. That is, in the case where the user inputs neither the history display instruction nor the end instruction, contents are extracted on the basis of the key sentence that was extracted from the content set as the process target in step S14, or on the basis of the key sentence that was input by the user in step S15, and a content selected from among the extracted contents, and a history record including the identification information for that content and the key sentence, are added respectively to document data 73 and history data 71 in HDD 107 for storage.

In step S28, a history displaying process is executed, and the process returns to step S13. The history displaying process, which will be described later in detail, is the process of displaying the contents stored up to then. Specifically, while the contents are stored as document data 73 in HDD 107 one after another during the period when the processes in steps S13 through S26 are executed, once the history display instruction is accepted, the contents stored as document data 73 by that time are displayed. As a result, during the time when the contents are being stored as document data, the user can confirm the contents stored up to then.

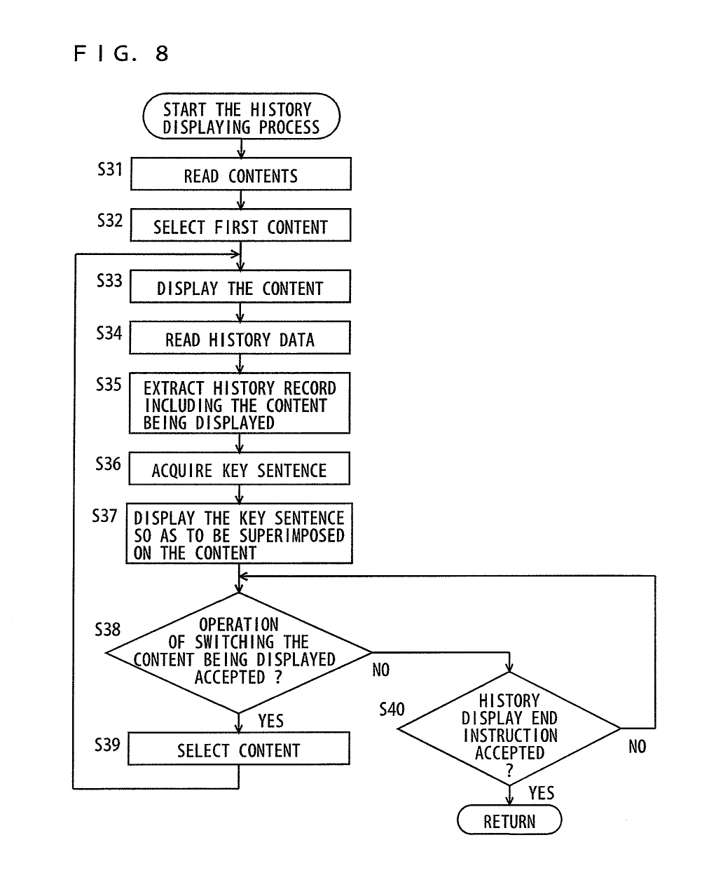

FIG. 8 is a flowchart illustrating an example of the flow of the history displaying process, which is executed in step S28 in FIG. 7. Referring to FIG. 8, CPU 101 reads the contents stored as document data 73 in HDD 107 (step S31). In the following step S32, a first one of the read contents is selected as a process target. In the following step S33, the content selected as the process target is displayed on display portion 117. In the following step S34, the history records stored as history data 71 in HDD 107 are read. In the following step S35, the history record including the content identification information for the content selected as the process target is extracted. Then, the key sentence included in the extracted history record is acquired (step S36). In the following step S37, the acquired key sentence is displayed superimposed on the content. Specifically, the content selected as the process target is displayed on display portion 117 in step S33. Then, in step S37, the key sentence is displayed so as to be superimposed on the content that has been set as the process target and that is being displayed on display portion 117. This allows the user to confirm the information included in the content and also confirm the key sentence based on which the content was extracted.

In the following step S38, it is determined whether an operation of switching the content displayed on display portion 117 has been accepted. If operation portion 115 has accepted an operation of switching the content to be displayed, the process proceeds to step S39; otherwise, the process proceeds to step S40. In step S39, the next content is selected, and the process returns to step S33. This enables the plurality of contents stored as document data 73 in HDD 107 to be displayed one after another, so that the user is informed of the plurality of contents stored as document data 73 one by one. By looking at the stored contents one after the other, the user can recall the thought process at the time when the user had stored those contents.

On the other hand, in step S40, it is determined whether a history display end instruction has been accepted. In the case where the user presses a key in operation portion 115 to which a history display end instruction has been assigned in advance, the history display end instruction is accepted. If the history display end instruction is accepted, the process returns to the content collecting process; otherwise, the process returns to step S38.

As described above, PC 100 according to the present embodiment functions as the content collecting apparatus, which sets one or more keywords extracted from a key sentence input by a user as search keywords, and causes search server 211 to perform search using the search keywords, to thereby acquire one or more contents received from search server 211. When the user selects one of the contents, PC 100 stores history data 71 in which the selected content is associated with the key sentence. Thereafter, when the user inputs another key sentence or causes a new key sentence to be extracted from the previously selected content, PC 100 adds one or more keywords extracted from the new key sentence to the search keywords, and causes search server 211 to perform search using the resultant search keywords, to thereby acquire one or more contents received from search server 211. When the user selects one of the contents, PC 100 additionally stores history data 71 in which the selected content and the key sentence are associated with each other. As such, when a content is selected, the content and the key sentence that has been used for searching for that content are stored in such a manner that they are associated with each other, and thus, the process in which the content was determined can be stored. As a result, it is possible to store the process in which a plurality of contents were determined.

Furthermore, in the case where the stored content is displayed, the key sentence that is associated with that content by history data 71 is displayed superimposed on the content being displayed, allowing the user to confirm the keyword and the content without the need of switching the screen.

Still further, a new key sentence is extracted from the content selected by the user, thereby enabling automatic setting of new keywords.

When the user inputs a key sentence, keywords are extracted. This allows the user to input different key sentences successively.

Furthermore, the plurality of contents received from search server 211 as the search result are sorted in such a manner that the content including an image is given a higher priority than the content including no image. This enables the content having a greater utility value as a document for use in presentation to be displayed in preference.

While PC 100 has been described as an example of the content collecting apparatus in the above embodiment, the present invention may of course be understood as a content collecting method for causing PC 100 to perform the processing shown in FIGS. 6 to 8, or as a content colleting program for causing CPU 101 controlling PC 100 to perform the content collecting method.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A content collecting apparatus, comprising:
a key sentence accepting portion to accept a key sentence externally input;
a first keyword extracting portion to extract one or more keywords from said accepted key sentence;
a keyword setting portion to set said extracted one or more keywords as search keywords;
a first content acquiring portion, in response to an event that said extracted one or more keywords are set as search keywords by said keyword setting portion, to acquire one or more contents extracted by performing search using the one or more keywords set as said search keywords;
a first selecting portion to select at least one of the one or more contents acquired by said first content acquiring portion;
a content storing portion to store the content selected by said first selecting portion;
a history storing portion to store history data in which the content selected by said first selecting portion is associated with the key sentence accepted by said key sentence accepting portion;
a key sentence acquiring portion to acquire a new key sentence;
a second keyword extracting portion, in response to an event that a new key sentence is acquired by said key sentence acquiring portion, to extract one or more new keywords from said acquired new key sentence;
a keyword adding portion, in response to an event that one or more new keywords are extracted, to add said extracted one or more new keywords to the search keywords;
a second content acquiring portion, in response to an event that said one or more new keywords are added to the search keywords, to acquire one or more contents extracted by performing search using the one or more keywords set as said search keywords;
a second selecting portion to select at least one of the one or more contents acquired by said second content acquiring portion;
a content adding and storing portion to add the content selected by said second selecting portion to said stored content for storage; and
a history adding portion, in response to an event that the content is selected by said second selecting portion, to add to said stored history data new history data in which said selected content is associated with said acquired new key sentence.

2. The content collecting apparatus according to claim 1, further comprising:
a content displaying portion to display said stored content; and
a key sentence displaying portion to display said key sentence that is associated with said displayed content by said stored history data, in such a manner that said key sentence is superimposed on said displayed content.

3. The content collecting apparatus according to claim 1, wherein said key sentence acquiring portion includes a first key sentence extracting portion to extract a new key sentence from the content selected by said first selecting portion.

4. The content collecting apparatus according to claim 1, wherein said key sentence acquiring portion includes a second key sentence extracting portion to extract a new key sentence from the content selected by said second selecting portion.

5. The content collecting apparatus according to claim 1, wherein in the case where a new key sentence externally input is accepted by said key sentence accepting portion, said key sentence acquiring portion acquires the accepted new key sentence.

6. The content collecting apparatus according to claim 1, wherein said first selecting portion and said second selecting portion are each configured to select, from among said one or more contents, a content including an image in preference to a content including no image.

7. A content collecting method, comprising:
a step of accepting a key sentence externally input;
a step of extracting one or more keywords from said accepted key sentence;
a step of setting said extracted one or more keywords as search keywords;
a first acquiring step of, in response to an event that said extracted one or more keywords are set as search keywords, acquiring one or more contents extracted by performing search using the one or more keywords set as said search keywords;
a first selecting step of selecting at least one of the one or more contents acquired in said first acquiring step;
a step of storing the content selected in said first selecting step;
a step of storing history data in which the content selected in said first selecting step is associated with said externally input key sentence;
a step of acquiring a new key sentence;
a step of, in response to an event that said new key sentence is acquired, extracting one or more new keywords from said acquired new key sentence;
a step of, in response to an event that one or more new keywords are extracted, adding said extracted one or more new keywords to the search keywords;
a second acquiring step of, in response to an event that said one or more new keywords are added to the search keywords, acquiring one or more contents extracted by performing search using the one or more keywords set as said search keywords;
a second selecting step of selecting at least one of the one or more contents acquired in said second acquiring step;
a step of adding the content selected in said second selecting step to said stored content for storage; and
a step of, in response to an event that the content is selected in said second selecting step, adding to said stored history data new history data in which said selected content is associated with said acquired new key sentence.

8. The content collecting method according to claim 7, further comprising:
a step of displaying said stored content; and
a step of displaying said key sentence that is associated with said displayed content by said stored history data, in such a manner that said key sentence is superimposed on said displayed content.

9. The content collecting method according to claim 7, wherein said key sentence acquiring step includes a first key sentence extracting step of extracting a new key sentence from the content selected in said first selecting step.

10. The content collecting method according to claim 7, wherein said key sentence acquiring step includes a second key sentence extracting step of extracting a new key sentence from the content selected in said second selecting step.

11. The content collecting method according to claim 7, wherein said key sentence acquiring step includes a step of, in the case where a new key sentence externally input is accepted in said key sentence accepting step, acquiring the accepted new key sentence.

12. The content collecting method according to claim 7, wherein said first selecting step and said second selecting step each include a step of selecting, from among said one or more contents, a content including an image in preference to a content including no image.

13. A non-transitory computer-readable recording medium encoded with a content collecting program, the content collecting program causing a computer to execute:
a step of accepting a key sentence externally input;
a step of extracting one or more keywords from said accepted key sentence;
a step of setting said extracted one or more keywords as search keywords;
a first acquiring step of, in response to an event that said extracted one or more keywords are set as search keywords, acquiring one or more contents extracted by performing search using the one or more keywords set as said search keywords;
a first selecting step of selecting at least one of the one or more contents acquired in said first acquiring step;
a step of storing the content selected in said first selecting step;
a step of storing history data in which the content selected in said first selecting step is associated with said externally input key sentence;
a step of acquiring a new key sentence;
a step of, in response to an event that said new key sentence is acquired, extracting one or more new keywords from said acquired new key sentence;
a step of, in response to an event that one or more new keywords are extracted, adding said extracted one or more new keywords to the search keywords;
a second acquiring step of, in response to an event that said one or more new keywords are added to the search keywords, acquiring one or more contents extracted by performing search using the one or more keywords set as said search keywords;
a second selecting step of selecting at least one of the one or more contents acquired in said second acquiring step;
a step of adding the content selected in said second selecting step to said stored content for storage; and
a step of, in response to an event that the content is selected in said second selecting step, adding to said stored history data new history data in which said selected content is associated with said acquired new key sentence.

14. The non-transitory computer-readable recording medium encoded with the content collecting program according to claim 13, wherein the content collecting program causes the computer to further execute:
a step of displaying said stored content; and
a step of displaying said key sentence that is associated with said displayed content by said stored history data, in such a manner that said key sentence is superimposed on said displayed content.

15. The non-transitory computer-readable recording medium encoded with the content collecting program according to claim 13, wherein said key sentence acquiring step includes a first key sentence extracting step of extracting a new key sentence from the content selected in said first selecting step.

16. The non-transitory computer-readable recording medium encoded with the content collecting program according to claim 13, wherein said key sentence acquiring step includes a second key sentence extracting step of extracting a new key sentence from the content selected in said second selecting step.

17. The non-transitory computer-readable recording medium encoded with the content collecting program according to claim 13, wherein said key sentence acquiring step includes a step of, in the case where a new key sentence externally input is accepted in said key sentence accepting step, acquiring the accepted new key sentence.

18. The non-transitory computer-readable recording medium encoded with the content collecting program according to claim 13, wherein said first selecting step and said second selecting step each include a step of selecting, from among said one or more contents, a content including an image in preference to a content including no image.
